(19) United States
(12) Patent Application Publication
(10) Pub. No.: US 2015/0381778 A1
(43) Pub. Date: Dec. 31, 2015

(54) MULTI-PANEL OR SEGMENT ENCLOSURE FOR A COMPUTING DEVICE

(71) Applicant: Kobo Inc., Toronto (CA)

(72) Inventor: Benjamin Landau, Toronto (CA)

(21) Appl. No.: 14/319,732

(22) Filed: Jun. 30, 2014

(51) Int. Cl. H04M 1/02; H04B 1/3888; H04M 1/04

(52) U.S. Cl. CPC H04M 1/0202; H04M 1/04; H04B 1/3888

(57) ABSTRACT

A cover for a computing device includes a base segment to support the computing device, and multiple panels that extend from a bottom end of the base segment. Each panel is pivotably coupled to at least one other panel of the multiple panels in order to pivot between at least an extended position and a raised position. At least some of the multiple panels each include one or more magnetized perimeter edges that support a position of the panel relative to another one of the multiple panels.

### TECHNICAL FIELD

Examples described herein relate to a multi-panel or segment enclosure for a computing device.

### BACKGROUND

An electronic personal display is a mobile electronic device that displays information to a user. While an electronic personal display may be capable of many of the functions of a personal computer, a user can typically interact directly with an electronic personal display without the use of a keyboard that is separate from or coupled to but distinct from the electronic personal display itself. Some examples of electronic personal displays include mobile digital devices/tablet computers such (e.g., Apple iPad®, Microsoft® Surface™, Samsung Galaxy Tab® and the like), handheld multimedia smartphones (e.g., Apple iPhone®, Samsung Galaxy S®, and the like), and handheld electronic readers (e.g., Amazon Kindle®, Barnes and Noble Nook®, Kobo Aura HD, and the like).

An electronic reader, also known as an e-reader, is an electronic personal display that is used for reading electronic books (eBooks), electronic magazines, and other digital content. For example, digital content of an eBook is displayed as alphanumeric characters and/or graphic images on a display of an e-reader such that a user may read the digital content much in the same way as reading the analog content of a printed page in a paper-based book. An e-reader provides a convenient format to store, transport, and view a large collection of digital content that would otherwise potentially take up a large volume of space in traditional paper format.

In some instances, e-readers are purpose built devices designed especially to perform especially well at displaying readable content. For example, a purpose built e-reader may include a display that reduces glare, performs well in high light conditions, and/or mimics the look of text on actual paper. While such purpose built e-readers may excel at displaying content for a user to read, they may also perform other functions, such as displaying images, emitting audio, recording audio, and web surfing, among others.

There also exists numerous kinds of consumer devices that can receive services and resources from a network service. Such devices can operate applications or provide other functionality that links the device to a particular account of a specific service. For example, e-reader devices typically link to an online bookstore, and media playback devices often include applications which enable the user to access an online media library. In this context, the user accounts can enable the user to receive the full benefit and functionality of the device.

### BRIEF DESCRIPTION OF THE DRAWINGS

FIG. 1 illustrates an example system for operating a computing device assembly to display e-books and other content, according to an embodiment.

FIG. 2 illustrates an example of an e-reader device or other electronic personal display device, for use with one or more embodiments described herein.

FIG. 3 is an isometric view of a computing device that is coupled to a cover, in accordance with one or more embodiments.

FIG. 4 and FIG. 5 illustrate an example of a cover without a corresponding computing device.

FIG. 6 illustrates a bottom view of an example of a cover.

FIG. 7 through FIG. 10 illustrates multiple side views of an example of a cover for a computing device, with the cover being oriented in different positions to support and protect the computing device.

FIG. 11 illustrates another example of a configuration that can be achieved by panels of an example cover, according to an embodiment.

FIG. 12A through FIG. 12D illustrate another example of a configuration for a cover.

### DETAILED DESCRIPTION

Examples described herein provide for a multi-panel or multi-segment cover for a computing device. According to one aspect, one or more panels of the cover are magnetized about a perimeter in order to enable the creation of magnetic forces for coupling to other panels, other portions of the cover, or to a computing device that is enclosed by the cover. Among other benefits, the use of perimeter magnetization efficiently distributes magnetic material to conserve cost while maintaining effectiveness.

In still another aspect, a cover is provided side segments which can extend upward to occlude peripheral line of sight to the display screen of an enclosed computing device. Still further, the side segments can also be magnetized to promote stable positioning of the side segments in the upright position, as well as ease of use.

According to one aspect, a cover is provided for a computing device. The cover includes a back segment, a first panel, and a pair of side segments. The base segment is structured to support the computing device from its bottom facade. The first panel is pivotably coupled to a bottom end of the base segment to at least partially overlay a portion of a front surface of the computing device. The pair of side segments each extend outward from a corresponding lateral side of the back segment. Each side segment is pivotably coupled to move into a raised position that extends vertically from the base segment relative to a perpendicular axis to the base segment. Each side segment of the pair is also dimensioned to occlude a display of the computing device from a corresponding peripheral direction.

In still another implementation, a cover for a computing device includes a base segment to support the computing device, and multiple panels that extend from a bottom end of the base segment. Each panel is pivotably coupled to at least one other panel of the multiple panels in order to pivot between at least an extended position and a raised position. At least some of the multiple panels each include one or more magnetized perimeter edges that support a position of the panel relative to another one of the multiple panels.

One or more embodiments described herein provide that methods, techniques and actions performed by a computing device are performed programmatically, or as a computer-implemented method. Programmatically means through the use of code, or computer-executable instructions. A programmatically performed step may or may not be automatic.

One or more embodiments described herein may be implemented using programmatic modules or components. A programmatic module or component may include a program, a subroutine, a portion of a program, or a software or a hardware component capable of performing one or more stated tasks or functions. As used herein, a module or component can exist on a hardware component independently of other modules or components. Alternatively, a module or component can be a shared element or process of other modules, programs or machines.

Furthermore, one or more embodiments described herein may be implemented through instructions that are executable by one or more processors. These instructions may be carried on a computer-readable medium. Machines shown or described with figures below provide examples of processing resources and computer-readable mediums on which instructions for implementing embodiments of the invention can be carried and/or executed. In particular, the numerous machines shown with embodiments of the invention include processor(s) and various forms of memory for holding data and instructions. Examples of computer-readable mediums include permanent memory storage devices, such as hard drives on personal computers or servers. Other examples of computer storage mediums include portable storage units, such as CD or DVD units, flash or solid state memory (such as carried on many cell phones and consumer electronic devices) and magnetic memory. Computers, terminals, network enabled devices (e.g., mobile devices such as cell phones) are all examples of machines and devices that utilize processors, memory, and instructions stored on computer-readable mediums. Additionally, embodiments may be implemented in the form of computer-programs, or a computer usable carrier medium capable of carrying such a program.

System and Device Description

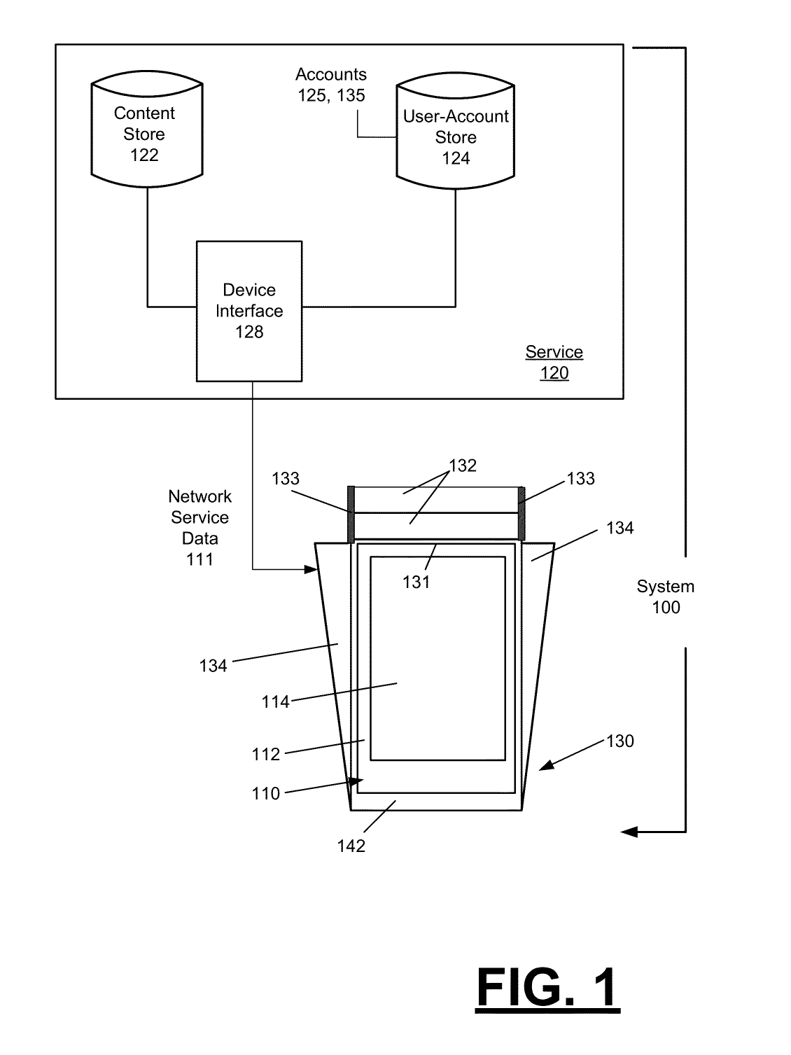

FIG. 1 illustrates a system for operating a computing device assembly to display e-books and other content, according to an embodiment. In an example of FIG. 1, the computing device assembly includes an electronic display device, shown by way of example as an e-reader device 110, and a cover 130. The cover 130 is an example of an accessory device which encloses (or at least partially encloses) the computing device in order to provide support, protection and/or privacy.

The network service 120 can communicate with the e-reader device 110 in order to, for example, deliver e-books or other forms of content items. In an example of FIG. 1, the network service 120 can include multiple servers and other computing resources that provide various services in connection with one or more applications that are installed on the e-reader device 110. By way of example, in one implementation, the network service 120 can provide e-book services which communicate with the e-reader device 110. The e-book services provided through network service 120 can, for example, include services in which e-books are sold, shared, downloaded and/or stored. More generally, the network service 120 can provide various other content services, including content rendering services (e.g., streaming media) or other network-application environments or services.

The e-reader device 110 can correspond to any electronic personal display device on which applications and application resources (e.g., e-books, media files, documents) can be rendered and consumed. For example, the e-reader device 110 can correspond to a tablet or a telephony/messaging device (e.g., smart phone). In one implementation, for example, e-reader device 110 can run an e-reader application that links the device to the network service 120 and enables e-books provided through the service to be viewed and consumed. In another implementation, the e-reader device 110 can run a media playback or streaming application which receives files or streaming data from the network service 120. By way of example, the e-reader device 110 can be equipped with hardware and software to optimize certain application activities, such as rendering of electronic content (e.g., e-books). For example, the e-reader device 110 can have a tablet like form factor, although variations are possible. With reference to FIG. 1, the e-reader device 110 includes a housing 112 and a display surface 114. The display surface 114 forms a front facade of the housing 112. In some implementations, the display surface 114 can correspond to an E-ink display.

In additional detail, the network service 120 can include a device interface 128, a resource store 122, and a user account store 124. The device interface 128 communicates with individual e-reader devices 110. In particular, the device interface 128 can communicate with individual e-reader devices in order to identify the accounts 125 of the users of such devices, and further to provide various services for downloading or enabling transactions for content items provided through network service 120. The user account store 124 can associate the particular e-reader device 110 with a user and with an account 125. The account 125 can also be associated with one or more application resources (e.g., e-books), which can be stored in the resource store 122. As described further, the user account store 124 can retain metadata for individual accounts 125 to identify resources that have been purchased or made available for consumption for a given account. The e-reader device 110 may be associated with the user account 125, and multiple devices may be associated with the same account. As described in greater detail below, the e-reader device 110 can store resources (e.g., e-books) that are purchased or otherwise made available to the user of the e-reader device 110, as well as to archive e-books and other digital content items that have been purchased for the user account 125, but are not stored on the particular computing device.

In an example of FIG. 1, e-reader device 110 is coupled to cover 130. The cover 130 can include multiple panels 132 that extend from a top end 131 of a base segment 142, and a pair of side segments 134 which extend laterally from the base segment. The base segment 142 can underlie or support the e-reader device 110 from a bottom facade (not shown), while providing a structure for the various segments. As described in examples provided herein, the panels 132 are positionable relative to the base segment 142 and/or the e-reader device 110 in order to raise, tilt or otherwise position the e-reader device relative to a reference (e.g., perspective of the user). More specifically, the individual panels 132 can pivot with respect to the top end 131, and further with respect to one another. The individual panels 132 can include magnetic strips 133 provided at a respective periphery or edge section. The magnetic strips 133 of individual panels can enable magnetic coupling or repulsion as between individual panels, the base segment and/or side segments 134. Among other uses, the magnetic forces provided by the magnetic strips 133 can stabilize the orientation of the panels relative to one another, the e-reader device 110 and/or the side segments 134.

This side segments 134 can extend laterally from the base segment 142, and further pivot between flat (or extended) and raised positions. As described with other examples, once the side segments 134 are in the raised positions, the side segments 134 in effect provide a privacy shield that occludes the display screen of the e-reader device 110 from a corresponding peripheral direction. At the same time, the user of the e-reader device 110 can view the display surface 114 from a straight-on perspective.

Hardware Description

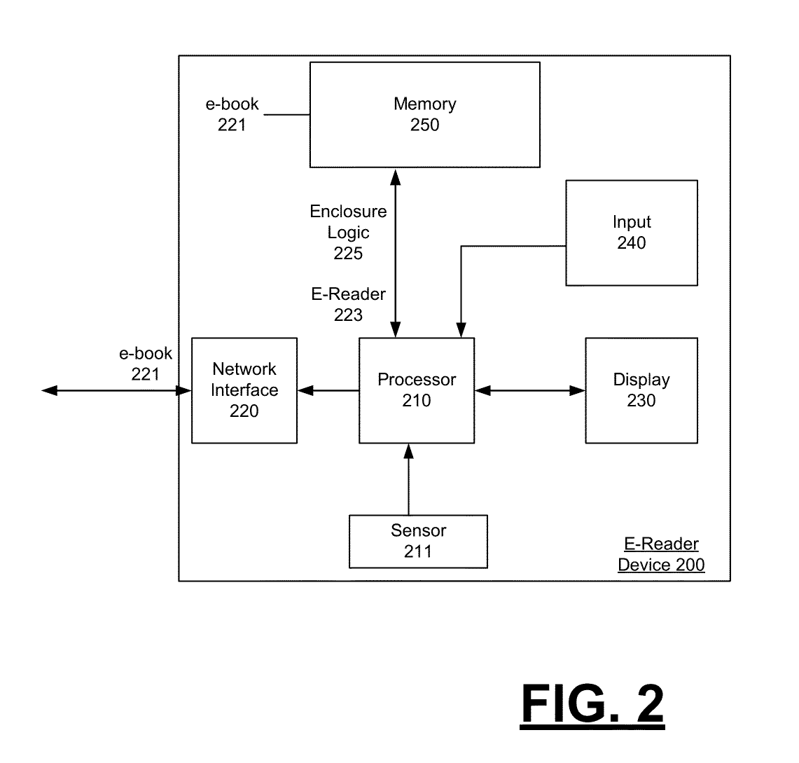

FIG. 2 illustrates an example of an e-reader device or other electronic personal display device, for use with one or more embodiments described herein. In an example of FIG. 2, an e-reader device 200 can correspond to, for example, a device, such as also shown by an example of FIG. 1. With reference to FIG. 2, e-reader device 200 includes a processor 210, a network interface 220, a display 230, one or more input mechanisms 240, and a memory 250.

The processor 210 can implement functionality using instructions stored in the memory 250. Additionally, in some implementations, the processor 210 utilizes the network interface 220 to communicate with the network service 120 (see FIG. 1). More specifically, the e-reader device 200 can access the network service 120 to receive various kinds of resources (e.g., digital content items such as e-books, configuration files, account information), as well as to provide information (e.g., user account information, service requests etc.). For example, e-reader device 200 can receive application resources, such as e-books 221 or media files that the user elects to purchase or otherwise download from the network service 120. The application resources that are downloaded onto the e-reader device 200 can be stored in the memory 250.

In some implementations, the display 230 can correspond to, for example, a liquid crystal display (LCD) or light emitting diode (LED) display that illuminates in order to provide content generated from processor 210. In some implementations, the display 230 can be touch-sensitive. In some variations, the display 230 can correspond to an electronic paper type display, which mimic conventional paper in the manner in which they display content. Examples of such display technologies include electrophoretic displays, electrowetting displays, and electrofluidic displays.

The processor 210 can receive input from various sources, including from input mechanisms 240 (e.g., buttons or switches, microphone, keyboard), the display 230 (e.g., soft buttons or keyboard) or other input mechanisms (accessory devices).

According to some embodiments, the memory 250 stores instructions 223 for implementing an e-reader component. The e-reader component can enable reading activities on, for example, display 230 (e.g., see display surface 114 of FIG. 1). Additionally, the memory 250 can store instructions that are responsive to various states of the cover (enclosure instructions 225). The enclosure instructions 225 can specify, settings or behavior of the computing device when the cover is in different states. For example, when the side segments 134 or raised so as to occlude peripheral viewing of the display surface 114, the processor 210 can execute the enclosure logic 225 to change the settings of the display 230 (e.g., brighten and/or sharp in contrast). Alternatively, functionality can be implemented based on the orientation of the panels and/or side segments 134. For example, when the side segments 134 are raised, the processor 210 can execute the e-reader instructions 223 to launch the e-reader automatically.

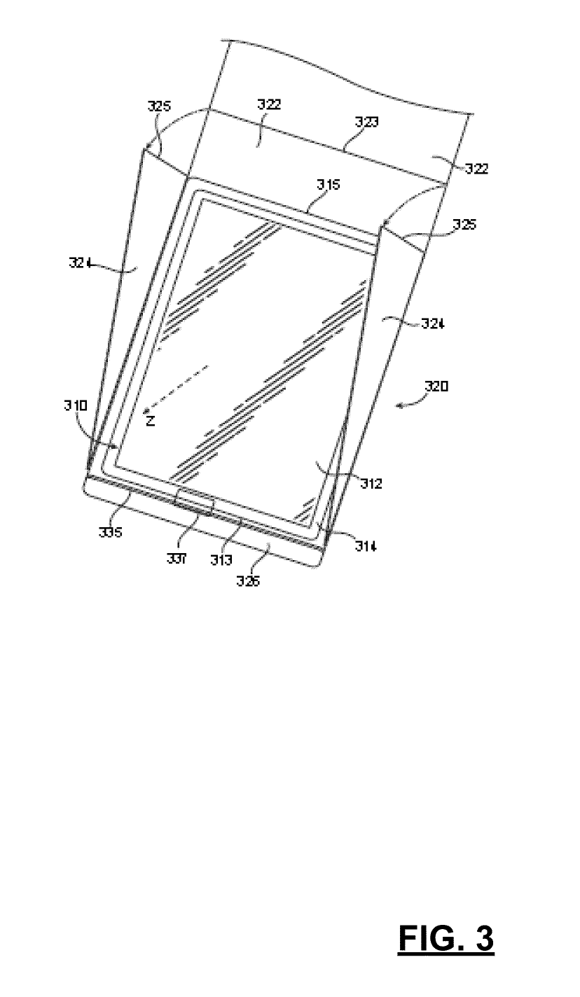

FIG. 3 is an isometric view of a computing device that is coupled to a cover, in accordance with one or more embodiments. In more detail, a computing device 310 (e.g., e-reader device 110 of FIG. 1) includes a display surface 312 and a housing 314. The computing device 310 is coupled to a cover 320 which includes multiple structures that can overlay and/or support the computing device 310.

According to one aspect, the cover 320 includes one or more panels 322, a pair of side segments 324 and a base segment 326. The panels 322 can extend from the top end 315 of the base segment 326. Multiple panels 322 can form the cover 320, and each panel 322 can be pivotable about another panel and/or the top end 315 of the base segment 326. As described with some examples, by pivoting, the panels 322 can collectively form multiple orientations that raise or tilt the computing device 310 relative to the perspective of the user.

In an example of FIG. 3, the pair of side segments 324 extends laterally from the base segment 326. The side segments 324 can pivot about the base segment 326 from, for example, an extended or horizontal position to a vertical or raised position (e.g., relative to axis Z). The side segments 324 can be dimensioned and/or shaped so as to occlude the displays surface 312 of the computing device 310 when raised.

According to one aspect, some structures or components of the cover device 310 can be magnetized. According to one aspect, the panels 322 are partially magnetized. In one implementation, the panels 322 include magnetized perimeters, such as magnetized vertical perimeter edges. The polarity assigned to the individual panels 322 can also alternate. In particular, adjacent panels 322 can have opposite polarity, creating magnetic attraction between the panels, and the magnetic attraction can serve to keep the two panels attached when brought together. In this way, the magnetization of the panels 322 can provide a stabilization force when, for example, two adjacent panels are used to support the computing device 310 in a partially upright position.

According to an embodiment, a top edge 325 of the individual side segments 324 can also be magnetized. The magnetization of the top edge 325 can enable the side segments 324 to be magnetically coupled to at least one of the panels 322 (assuming opposite polarity). More specifically, the panel most proximate to the top and 315 can be raised 90° (approximately) relative to the Z-axis (shown perpendicular to the display surface 312). Additionally, the side segments 324 can be raised relative to the Z-axis. When the most proximate panel 322 and the side segments 324 are raised, the peripheral edge 323 of the panel 322 and the top edges 325 of the side segment 324 can be brought to sufficient proximity to enable a magnetic coupling between the respective side segments 324 and the panel 322.

As shown by an example of FIG. 3, when the orientation of the raised side segments 324 and the panel 322 is maintained (such as by magnetic coupling), a three-sided privacy enclosure can be created to enable viewing of the display screen 312. A user can view the display screen 312 head-on. Depending on the length of the panels segments, the display screen 312 can also be raised or tilted. The combination of the panel 322 and the side segments 324 in the raised position occlude the display screen 312 from peripheral viewing, thus preserving the privacy of the user in viewing content provided on the display screen.

In one aspect, the computing device 310 can rest on a ledge 335 that is formed on the base segment 326. The ledge 335 supports the computing device 310 from a bottom 313. In some variations, the connector 337 is provided at the ledge 335 to mate with a corresponding connector of the computing device 310. In this way, the cover device 310 can extend functionality, such as providing power or connectivity, to the computing device 310.

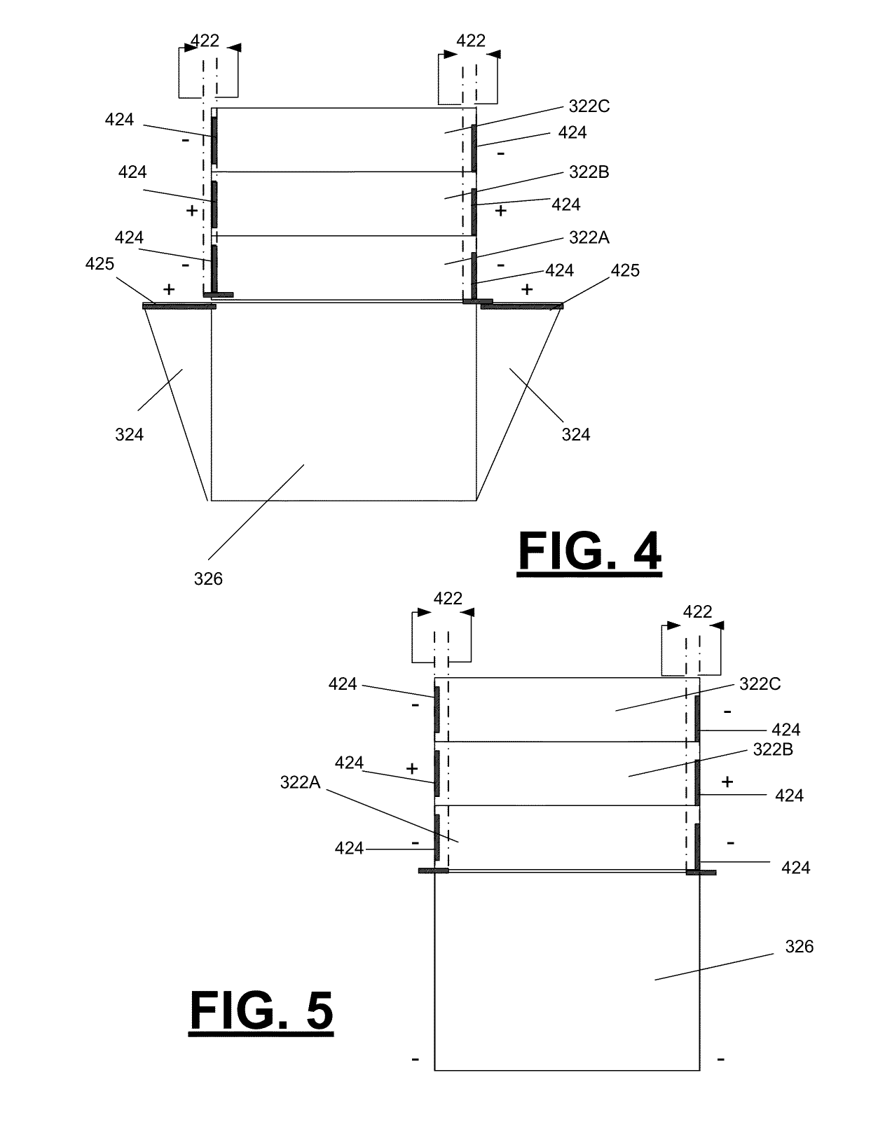

FIG. 4 and FIG. 5 illustrate the cover 320 without the computing device 310. In one implementation, cover 320 includes three panels 322, as well as the base segment 326, and the pair of side segment 324. In FIG. 4, the panels 322 are shown to be in an extended form, and the side segments 324 are shown to be in a flat or extended position. In FIG. 5, the panels 322 are shown to be an extended form, and the side segments 324 are raised relative to the Z-axis (out of paper).

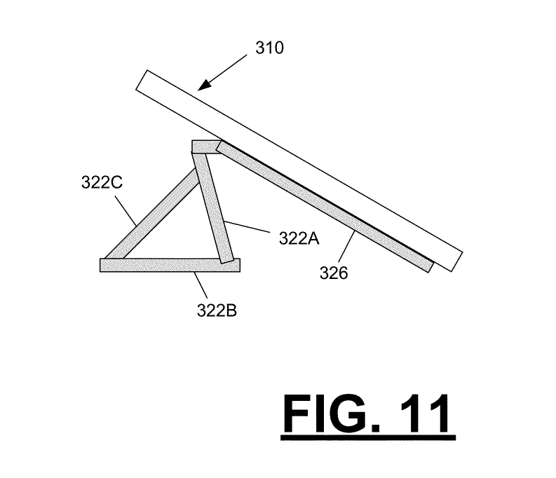

The pair of side segments 324 extend laterally from the base segment 326. Each panel 322 can also be pivotable about another panel. In particular, first panel 322A can be pivotable about a top end 315 of the base segment 326, second panel 322B can be pivotable about the first panel 322A, and the third panel 322C can be pivotable about the second panel 322B. Collectively, the panels 322 can be pivoted about the top end 315 of the base segment 326, so as to be positionable in multiple orientations, such as shown by FIG. 7 through FIG. 10.

Further, as shown, some variations provide for one or more of the panels 322 to be magnetized. In particular, the panels 322 can be magnetized about a perimeter or vertical edge section 422 of the individual panel 322. In one implementation, each panel 322 includes a pair of magnetic members 424, such as rods, which extend along the vertical edge section of the particular panel. Various kinds of material can extend between the vertical members 424 at the respective vertical edge section 422. By way of example, the flexible materials can be in the form of leather, plastic, cloth, rubber etc.

As an addition or variation, the magnetic polarity of the panels can be alternated, so that, for example, the polarity of the first segment 322A is negative, the polarity of the second panel 322B is positive, and the polarity of the third panel 322C is negative. Additionally, the side segments 324 can also be magnetized, such as through magnetic members provided at the edge sections 425 closest to the first panel 322A (see FIG. 4). When magnetized with reverse polarity, the first panel 322 can combine with the side segments 324 to provide a privacy enclosure for a display screen of the computing device.

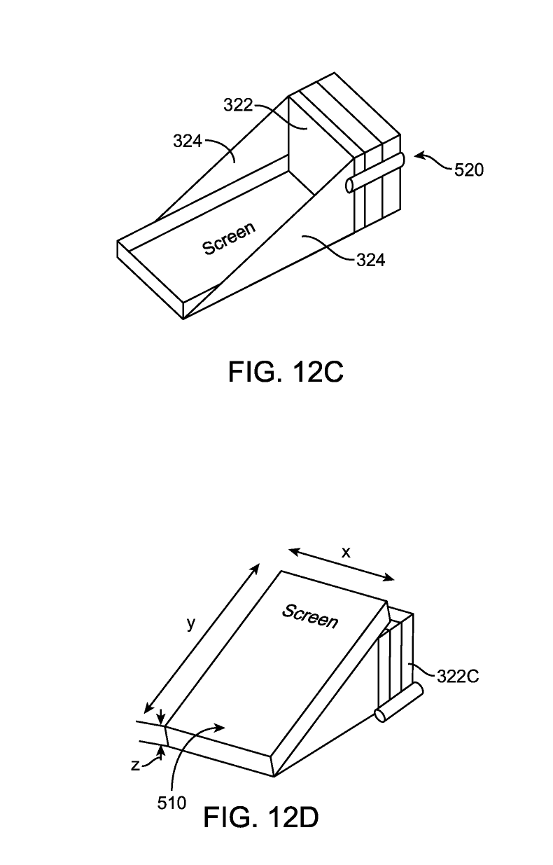

The dimensioning of the panels 322 and the side segments 324 can be based on design parameters, including the dimensions of the surfaces to be protected (e.g., length or width of the e-reader device), and the desired configuration for the panels and side segments. By way of example, FIG. 12A through FIG. 12D illustrate one set of dimensional criteria for enabling specific panel/segment configurations.

As an alternative or variation to magnetic members 424, some examples provide for use of discrete magnets, which can be positioned with one or more of the panels 322. FIG. 12A through FIG. 12D illustrate a variation that utilizes discretely positioned magnets in lieu of magnetic strips or members 424.

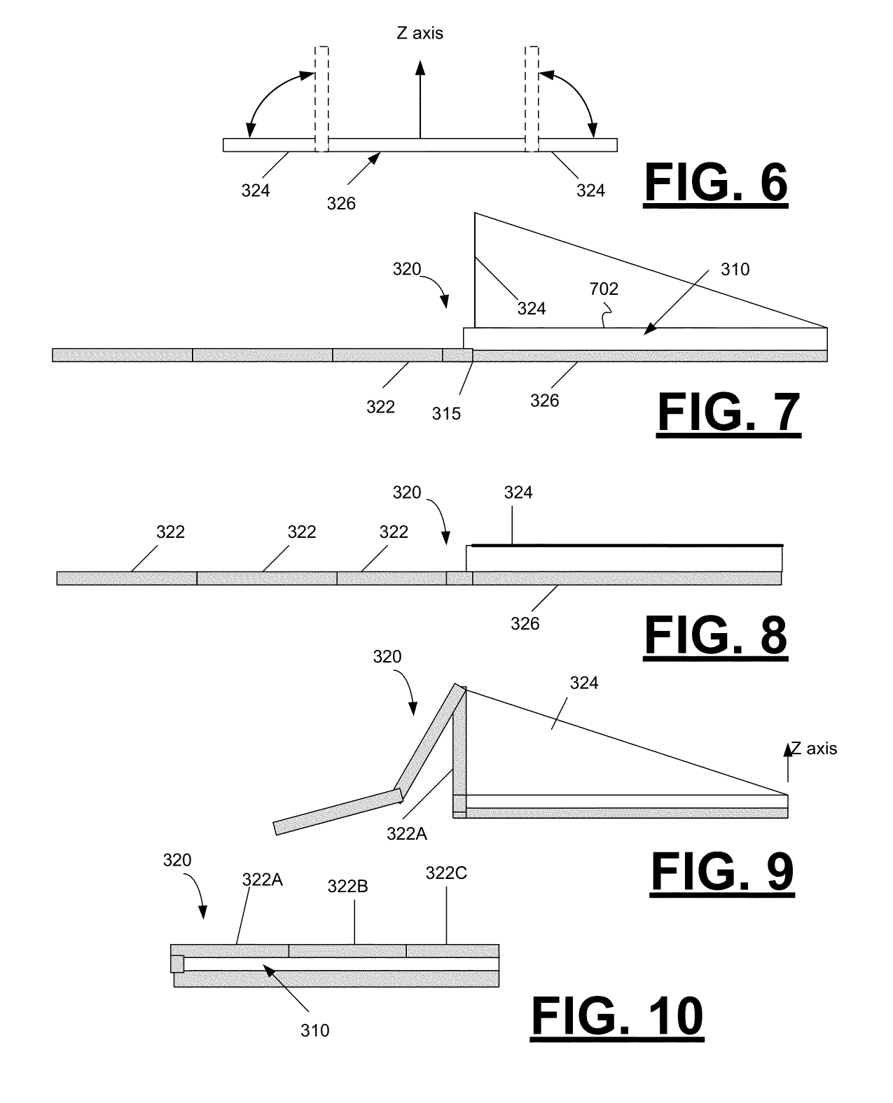

FIG. 6 illustrates a bottom view of the cover 320, according to one implementation. As shown by the bottom view perspective, cover 320 includes the base segment 326 which can support the computing device 310 from its bottom side (see e.g., FIG. 3). The side segments 324 can extend between a flat (or extended) position and a raised (or vertical) position. In the raised position, the side segments 324 extend vertically from the base segment 326 along the Z-axis. In the vertical position (shown in phantom), the side segments 324 can occlude peripheral viewing of the display screen 312, as shown by an example of FIG. 3.

FIG. 7 through FIG. 10 illustrates multiple side views of the cover and computing device, with the cover being oriented in different positions. In FIG. 7, the side segments 324 of the cover 320 are in the raised position, extending vertically above a front surface 702 of the computing device 310. As shown in an example, the shape of the side segments 324 can be triangular, with a greatest dimension of the side segments 324 being proximate to the first panel 322 and next to the top end 315 of the base segment 326.

In FIG. 8, the side segments 324 are flat or in the extended position. Additionally, the panels 322 are flat or in the extended position.

In FIG. 9, the first segment 322A and side segments 324 are raised. In the example provided, the first panel 322 and the side segments 324 are each pivoted upward so as to extend along the Z-axis. The first panel 322 and/or side segments 324 can be magnetized to enable magnetic coupling of the first panel 322 relative to the side segment 324 and/or other portion of the cover 320 or computing device 310.

FIG. 10 illustrates the cover 320 being configured to overlay and encase the computing device 310. In this orientation, the base segment 326 of the cover 320 supports the computing device 310 from the bottom surface, and the panels 322A, 322B and 322C are positioned to overlay a front surface of the computing device 310.

The panels 322 of the cover 320 can be manipulated in a variety of orientations in order to prop the computing device 310 in various positions. For example, the panel 322C can be bunched with the panel 322B and extended acutely from the panel 322A in order to provide a raised and tilted support structure. These and various other configurations can be enabled using the multi-paneled magnetized structure as shown with FIG. 7 through FIG. 10.

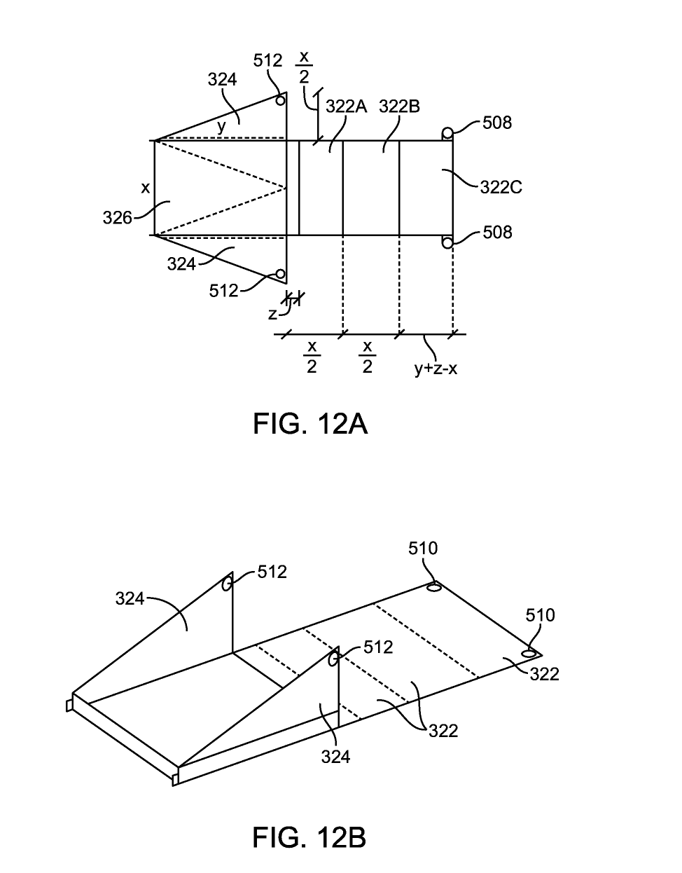

FIG. 11 illustrates another example of a configuration that can be achieved by panels of an example cover, according to an embodiment. The first panel 322A can be folded back underneath the base segment 326, the second panel 322B can be laid on the underlying surface, and the third panel 322C can be bent up to support the first panel 322A. The result is that the three panels 322 form a triangle under the segment 326. The computing device 310 can rest on the base segment 326 in a partially upright position. The triangular shape formed by the panels 322 create a reading stand for the computing device 310. Additionally, the triangular shape is stable and supportive of the computing device 310. In implementations in which the panels 322 are magnetized, the magnetic couplings between panels further stabilizes the configuration of the cover 320 in maintaining the computing device 310 upright.

FIG. 12A through FIG. 12D illustrate another example of a configuration for a cover. In the example of FIG. 12A through FIG. 12D, cover 300 is dimensioned based on design parameters to enable alternative user-selected panel configurations to enable viewing of the a display screen 542 of the e-reader device 510 in either a privacy configuration (see FIG. 12C) or book stand configuration (see FIG. 12D).

In FIG. 12A, the cover 300 is shown in open position without the e-reader device. For purpose of reference, let X=width of the e-reader device, Y=length of the e-reader device, and Z equal a thickness of the e-reader device. The dimensional references X, Y, and Z are shown in FIG. 12D in relation to the e-reader device 510. In one implementation, the lengthwise dimension (Lp)_of the panel 322A and 322B can be expressed as Lp=X/2, and the lengthwise dimension (Lp) of the panel 322C can be expressed as Lp=Y+Z−X. The distal panel 322C can include magnets 508, while other panels 322A and 322B contain no magnets. Additionally, a maximum height dimension (H) of the side segments 324 can be as H=X/2. The magnets 508 of the panels 322C can be discrete elements positioned at, for example, opposing corner sections of the panel. Likewise, the side segments 324 can include magnets 512, such as discrete corner magnets as shown in the example.

In FIG. 12B, the side segments 324 are shown in the raised position. In an example shown, the side segments 324 can include corner magnets 512 (or alternatively magnetic material). The user can move the side segments 324 into the raised position as a first step in forming the privacy configuration.

FIG. 12C shows the privacy configuration for the cover 300. In the privacy configuration, the side segments 324 are raised, and the distal panel 322C is folded in and brought against the intermediate panel 322B, and the combined panels are folded in against the proximate panel 322A. When brought together, the magnets 508 of the distal panel 322C can form a magnetic coupling 520 with the corner magnets 512 of the side segments 324. The magnetic coupling 520 can be sufficient to create a “snap” effect. The result of the coupling is that a 3-sided barrier is formed about the e-reader device 510, protecting the screen 515 of the device from peripheral line of sight.

FIG. 12D shows the book cover configuration, according to an embodiment. In the book cover configuration, the side segments 324 are folded under the e-reader device 510. The corner magnets 512 of the side segments 324 further couple with the magnet 508 of the distal panel 322C, creating a stable support for retaining the e-reader device in the upright position. The result is a strong wedge-shaped reading stand.

Although illustrative embodiments have been described in detail herein with reference to the accompanying drawings, variations to specific embodiments and details are encompassed by this disclosure. It is intended that the scope of embodiments described herein be defined by claims and their equivalents. Furthermore, it is contemplated that a particular feature described, either individually or as part of an embodiment, can be combined with other individually described features, or parts of other embodiments. Thus, absence of describing combinations should not preclude the inventor(s) from claiming rights to such combinations.

What is claimed is:

1. A cover for a computing device, the cover comprising:
a base segment to support the computing device;
a first panel that is pivotably coupled to a top end of the base segment to at least partially overlay a portion of a front surface of the computing device; and
a pair of side segments, each side segment pair extending outward from a corresponding lateral side of the base segment and being pivotably coupled to extend into a raised position that extends vertically from the base segment relative to a perpendicular axis to the base segment, each side segment of the pair being dimensioned to occlude a display of the computing device from a corresponding peripheral direction.

2. The cover of claim 1, wherein the first panel is extendable into a raised position that extends vertically from the base segment along the perpendicular axis, and wherein at least one of the first panel and each of the side segments of the pair are formed from magnetic material to magnetically couple when each of the first panel and the pair of side segments are in the raised position so that the first panel and the pair of side segments form a three-sided enclosure about the base segment.

3. The cover of claim 2, wherein at least the first panel is magnetized.

4. The cover of claim 3, wherein the first panel includes one or more side members that are magnetized.

5. The cover of claim 4, wherein the first panel is formed from flexible material that overlays and extends between the one or more side members.

6. The cover of claim 1, further comprising a second panel that is pivotably coupled to the first panel, wherein each of the first panel and the second panel is magnetized.

7. The cover of claim 1, wherein each of the first panel and second panel include one or more side members that are magnetized, and wherein each of the first panel and second panel is formed from flexible material that overlays and extends between the one or more side members.

8. The cover of claim 6, wherein a polarity of the first panel is different than a polarity of the second panel.

9. The cover of claim 6, further comprising one or more additional panels, each of the one or more additional panels being pivotably coupled to another one of the additional panels.

10. The cover of claim 9, wherein each of the one or more additional panels is magnetized.

11. The cover of claim 10, wherein a polarity of the first panel is opposite a polarity of the second panel, and wherein the polarity of the second panel is opposite to a polarity of an adjacent panel of the one or more adjacent panels.

12. The cover of claim 1, wherein each of the side segments are triangular.

13. The cover of claim 1, wherein a dimension of each of the side segments is greatest when extended from the base segment at closest proximity to the first panel.

14. A cover for a computing device, the cover comprising:
a base segment to support the computing device; and
multiple panels that extend from a bottom end of the base segment, each panel being pivotably coupled to at least one other panel of the multiple panels in order to pivot between at least an extended position and a raised position; and
wherein at least some of the multiple panels each include one or more magnetized perimeter edges that support a position of the panel relative to another one of the multiple panels.

15. The cover of claim 14, wherein a polarity of the one or more magnetized perimeter edges of individual panels alternates as between adjacent pairs of panels.

16. The cover of claim 14, wherein each of the multiple panels includes one or more side members that are magnetized, and wherein each of the multiple panels is formed from flexible material that overlays and extends between the one or more side members.

17. The cover of claim 14, wherein the multiple panels are pivotable so that the multiple panels collectively overlay a front surface of the computing device.

18. The cover of claim 14, further comprising:
a pair of side segments, each side segment pair extending outward from a corresponding lateral side of the base segment and being pivotably coupled to extend into a raised position that extends vertically from the base segment relative to a perpendicular axis to the base segment, each side segment of the pair being dimensioned to occlude a display of the computing device from a corresponding peripheral direction.

19. The cover of claim 18, wherein the pair of side segments include material that is magnetically attracted to a most proximate panel of the multiple panels.

20. The cover of claim 19, wherein the pair of side segments are triangular and pivotably coupled to the base segment.
